(19) United States
(12) Patent Application Publication
(10) Pub. No.: US 2025/0008037 A1
(43) Pub. Date: Jan. 2, 2025

(54) CONTROL APPARATUS AND CONTROL METHOD

(71) Applicant: CANON KABUSHIKI KAISHA, Tokyo (JP)

(72) Inventor: KAZUKI SAMO, Kanagawa (JP)

(21) Appl. No.: 18/677,683

(22) Filed: May 29, 2024

(30) Foreign Application Priority Data
Jun. 28, 2023 (JP) 2023-105854

(51) Int. Cl. H04N 1/00

(52) U.S. Cl. CPC H04N 1/00811; H04N 1/00925

(57) ABSTRACT

A control apparatus for controlling a scanner has a control unit configured to execute display control to display a reading parameter used for reading a document image by the scanner on a display unit in a case where a file of the document image is to be generated on a first condition and display both a generation parameter used for generating the file and the reading parameter on the display unit in a case where the file is to be generated on a second condition being different from the first condition.

### BACKGROUND OF THE INVENTION

### Field of the Invention

The present disclosure relates to a control apparatus and a control method.

### Description of the Related Art

An image reading apparatus (scanner) which scans a document and generates an image file is generally known. In a scanner, a reading parameter is preset by a user through a user interface (UI) such as a touch panel provided by an apparatus or a graphical user interface (GUI) which can be used on a PC which can be connected to the apparatus. The scanner carries out a scanning (reading) process by the use of the preset reading parameter.

Japanese Patent Laid-Open No. 2015-231219 (hereinafter referred to as Reference 1) discloses a technique of carrying out a file format conversion process and a resolution compression process in a case where the scanner generates an image file.

Reference 1 discloses an example in which a resolution of reading of an image is automatically changed according to a process carried out after image reading. In such a case, it is possible that a parameter preset by a user (a resolution of image reading) and a parameter of a generated file (for example, the resolution of a generated product) are different from each other.

### SUMMARY OF THE INVENTION

A control apparatus of an aspect of the present disclosure is a control apparatus for controlling a scanner and has a display unit and a control unit configured to execute display control to display a reading parameter used for reading a document image by the scanner on the display unit in a case where a file of the document image is to be generated on a first condition and to display both a generation parameter used for generating the file and the reading parameter on the display unit in a case where the file is to be generated on a second condition which is different from the first condition.

Further features of the present invention will become apparent from the following description of exemplary embodiments with reference to the attached drawings.

### BRIEF DESCRIPTION OF THE DRAWINGS

FIG. 1 is a diagram showing an example of an image processing system;

FIG. 2 is a block diagram showing an example of a hardware configuration of an MFP;

FIG. 3 is a block diagram showing an example of a software configuration of an MFP;

FIGS. 4A, 4B, 4C, and 4D are diagrams showing an example of a screen displayed on an operation unit;

FIGS. 5A and 5B are diagrams showing an example of the screen displayed on the operation unit;

FIG. 6 is a flow chart showing a display process of a screen including resolution settings;

FIGS. 7A and 7B are diagrams showing an example of a screen displayed on the operation unit;

FIG. 8 is a flow chart showing a display process of a screen including the resolution settings;

FIG. 9 is a flow chart of a process in a case of the acceptance of a user operation of changing the resolution settings;

FIGS. 10A and 10B are diagrams showing an example of a screen displayed on the operation unit; and

FIG. 11 is a flow chart showing a display process of a screen including the resolution settings.

### DESCRIPTION OF THE EMBODIMENTS

With reference to the attached drawings, a suitable embodiment of the present disclosure is explained in detail below. Incidentally, the following embodiments do not limit matters of the present disclosure, and not all combinations of features explained in the following embodiments are indispensable for a solution of the present disclosure. Incidentally, the same reference number is assigned to the same constituent element.

### First Embodiment

The present embodiment explains an example in which a user can properly recognize a parameter of file generation even in a case where a parameter used for reading a document image by a scanner (also referred to as reading parameter) is different from a parameter used for generating a file of the document image (also referred to as generation parameter). The present embodiment explains an example in which an MFP (Multifunction Peripheral) is used as a scanner. Further, a resolution is explained as an example of a parameter of the image reading and the file generation.

As an aspect, the user performs an operation of setting a parameter (resolution) of the image reading by the use of an operation screen of an MFP, for example, in a case where the user attempts to scan a desired document and obtain a document image. Incidentally, a setting operation may not be performed in a case where, for example, a parameter desired by the user is set by default. Then, in receiving an instruction to execute scanning from the user, the MFP performs reading (scanning) according to the set parameter of the image reading.

In some MFPs, after a process for reading an image at a set resolution is performed in a case where the set resolution is a predetermined resolution, a compression process in which only a background region in image data of the read image is made to have a lower resolution than the resolution of the reading is performed. As a result of the compression process, a file with a reduced data capacity is generated. In such a case, the resolution of the file actually generated is different from a resolution recognized by the user. An example in which the user can understand the parameter of the file generation even in such a case is explained below.

### (System Configuration)

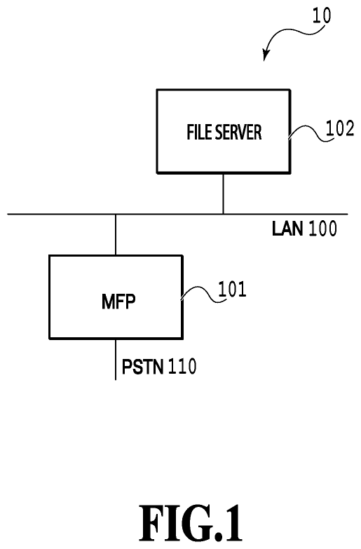

FIG. 1 is a diagram showing an example of an image processing system 10 in the present embodiment. On a LAN (Local Area Network) 100, an MFP 101 and a file server 102 are able to communicate with and are connected to each other. The MFP 101 is an example of an image processing apparatus. The file server 102 is an example of a file management apparatus.

The MFP 101 can perform file sending of image data to a folder in the file server 102 as a destination by the use of a file transfer protocol. As a file transfer protocol, SMB (Server Message Block) or FTP (File Transfer Protocol) is given as an example. Incidentally, a file sending destination of the MFP 101 is not limited to the file server 102, but a folder in a host PC not shown may be set as a destination. Further, the MFP 101 can send image data by e-mail through a mail server not shown. The MFP 101 is connected to a PSTN (Public Switched Telephone Network) 110 and can perform facsimile transmission and reception to and from a facsimile not shown. Further, the MFP 101 may be connected to the Internet not shown and may be configured to transmit data to other apparatuses through the Internet.

The MFP 101 can obtain and use a destination table via the LAN 100 in a case where the destination table stored in an appliance (for example, the file server 102) in the image processing system 10 is published.

Incidentally, the image processing system 10 includes the MFP 101 and the file server 102, but only the MFP 101 may be referred to as an image processing system. Further, an image processing system 10 including a host PC or a management server not illustrated may be referred to as an image processing system.

### (Hardware Configuration)

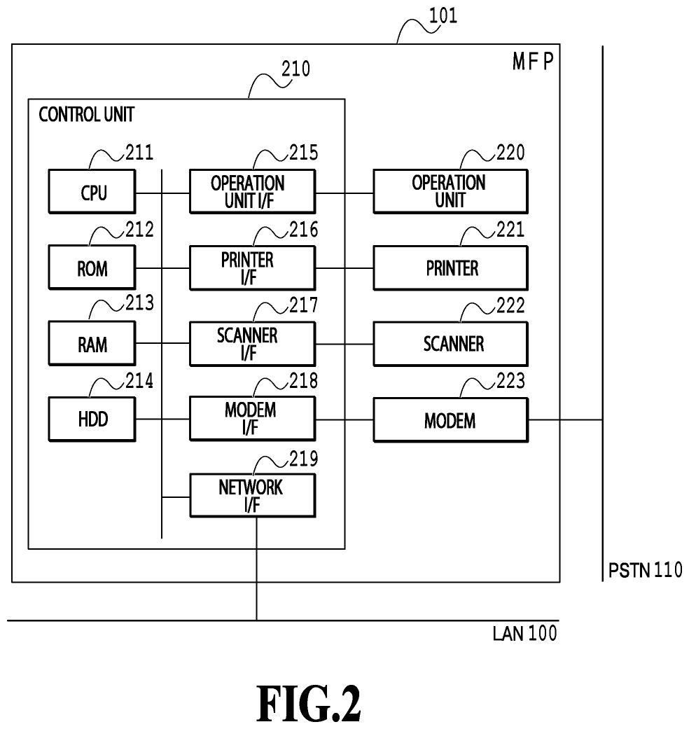

FIG. 2 is a block diagram showing an example of a hardware configuration of the MFP 101. The MFP 101 has a control unit 210, an operation unit 220, a printer 221, a scanner 222, and a modem 223. The control unit 210 has a CPU 211, a ROM 212, a RAM 213, a HDD 214, an operation unit I/F 215, a printer I/F 216, a scanner I/F 217, a modem I/F 218, and a network I/F 219.

The control unit 210 including the CPU 211 controls a total operation of the MFP 101. The CPU 211 reads a control program stored in the ROM 212 and performs various types of control such as reading control and sending control. The RAM 213 is used as a main memory of the CPU 211 and a transitory storage area such as a work area. Incidentally, the MFP 101 has an aspect in which one CPU 211 executes each process illustrated in a flow chart described later with one memory (the RAM 213 or the HDD 214), but the MFP 101 may have other aspects. For example, the MFP 101 may be configured to execute each of the processes illustrated in the flow chart described later by causing a plurality of CPUs and a plurality of RAMs or HDDs to cooperate.

The HDD 214 stores image data and various programs. The operation unit I/F 215 connects the operation unit 220 to the control unit 210. The operation unit 220 is provided with a liquid crystalline display unit having a touch panel function and a keyboard or the like.

The printer I/F 216 connects the printer 221 to the control unit 210. Image data used for printing in the printer 221 is transferred from the control unit 210 through the printer I/F 216, and is printed on a printing medium in the printer 221. Incidentally, a printing system of the printer 221 used in the present embodiment may be an electrophotographic system, an ink jet system, or other systems.

The scanner I/F 217 connects the scanner 222 to the control unit 210. The scanner 222 reads an image on a document and generates image data (image file), and inputs the image data to the control unit 210 through the scanner I/F 217. The MFP 101 can perform file sending or mail sending of the image data (image file) generated by the scanner 222.

The modem I/F 218 connects the modem 223 to the control unit 210. The modem 223 connects the control unit 210 (MFP 101) to a PSTN 110. The modem 223 executes facsimile transmission and reception to and from a facsimile on the PSTN 110.

The network I/F 219 connects the control unit 210 (MFP 101) to the LAN 100. The network I/F 219 transmits image data and information to an external apparatus (for example, the file server 102) on the LAN 100 and receives various types of information from the external apparatus on the LAN 100.

### (Software Configuration)

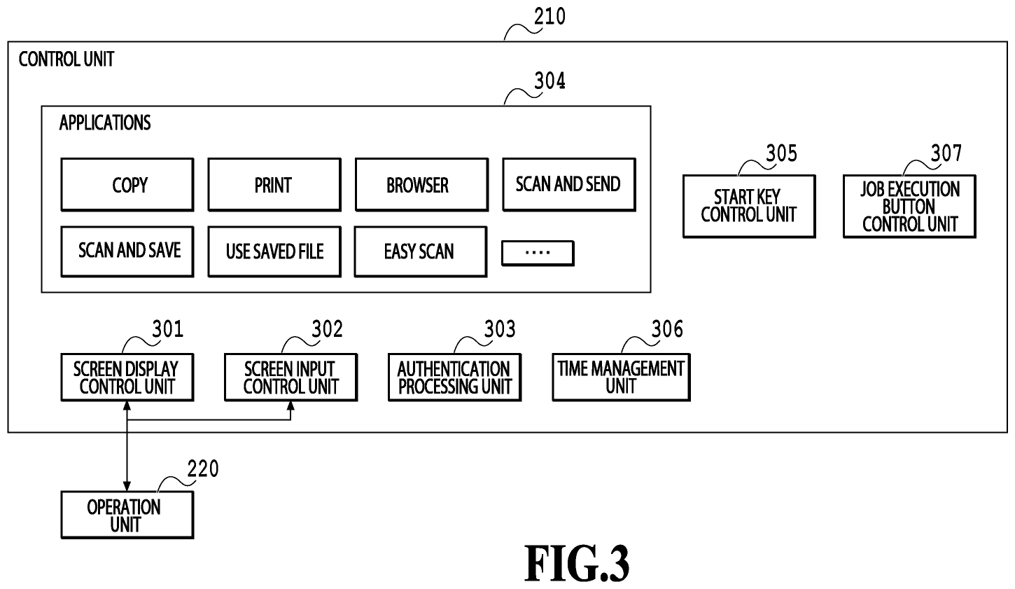

FIG. 3 is a block diagram showing an example of a software configuration of the MFP 101. Incidentally, in the present embodiment, except where specifically noted, an exchange between illustrated software modules is implemented by a process performed by the CPU 211 according to a program stored in the ROM 212 or HDD 214. The CPU 211 controls the ROM 212, the RAM 213, the HDD 214, the operation unit I/F 215, the printer I/F 216, the scanner I/F 217, the modem I/F 218, and the network I/F 219.

The control unit 210 has a screen display control unit 301, a screen input control unit 302, an authentication processing unit 303, an application 304, a start key control unit 305, a time management unit 306, and a job execution button control unit 307.

The screen display control unit 301 mainly performs screen management of the whole of the application 304, a process for transferring information of a screen to the operation unit 220, and a process for notifying the application 304 of an event input from the operation unit 220.

In the screen input control unit 302, the operation unit I/F 215 converts an operation from the operation unit 220 into a signal, receives and analyzes the signal, and converts the signal into an input signal in a format of an event which can be transmitted to the application 304. Further, the screen input control unit 302 notifies the screen display control unit 301 of the input signal.

The authentication processing unit 303 displays an authentication screen on the operation unit 220 and performs user authentication by the use of authentication information such as ID and a password input from the user. In a case where the user authentication is successful, the authentication processing unit 303 performs a login process for causing a corresponding user to log in to the MFP 101. In a case where logout is instructed, the authentication processing unit 303 performs a logout process for causing a login user to log out of the MFP 101.

The Application 304 is a group of applications operating on the MFP 101, and the CPU 211 operates each application by an instruction from the user through the screen input control 302. The following are typical applications of the applications the MFP 101 has:
An application program having a “copy” function of printing image data generated by reading an image on a document by the scanner 222 in the printer 221;
An application program having a “print” function of printing the image data based on a print job introduced from an external apparatus such as a PC in the printer 221;
An application program having a “scan and send” function of sending the image data generated by reading the image on the document by the scanner 222 to the outside;
An application program having a “scan and save” function of saving the image data generated by reading the image on the document by the scanner 222 in an external memory;
An application program having a “use a saved file” function of printing the image data saved in the external memory in the printer 221 or sending the image data saved in the external memory to the outside;
An application program having a “browser” function of viewing, printing, and saving data on a web server through a web browser; and
An application program having an “easy scan” function in which the “scan and send” function is limited to a part of main settings and is made to be easy to use.

Incidentally, the application 304 which the MFP 101 has is not limited to the above example. Further, the application 304 can be added afterward by an instruction of the user.

The start key control unit 305 detects that a start key is depressed by the screen input control unit 302, and sends a notification of a start key execution to the application 304. The application 304 which receives the notification of the start key execution executes a corresponding function.

The time management unit 306 manages a current time from the activation of the MFP 101, and the current time is notified by an instruction from the start key control unit 305 or job execution button control unit 307.

The job execution button control unit 307 performs a setting of a function of a corresponding application by an instruction from the user and stores the setting in the HDD 214. Further, the job execution button control unit 307 detects that a registered job execution button is depressed, calls a corresponding application 304, and executes the application 304 at the setting registered in advance and stored in the HDD 214.

Incidentally, a configuration shown in FIG. 3 is only an example, and the present disclosure is not limited to this example. A part of the configuration of FIG. 3 may be eliminated, and other configurations may be added to the configuration of FIG. 3.

### (Operation Screen)

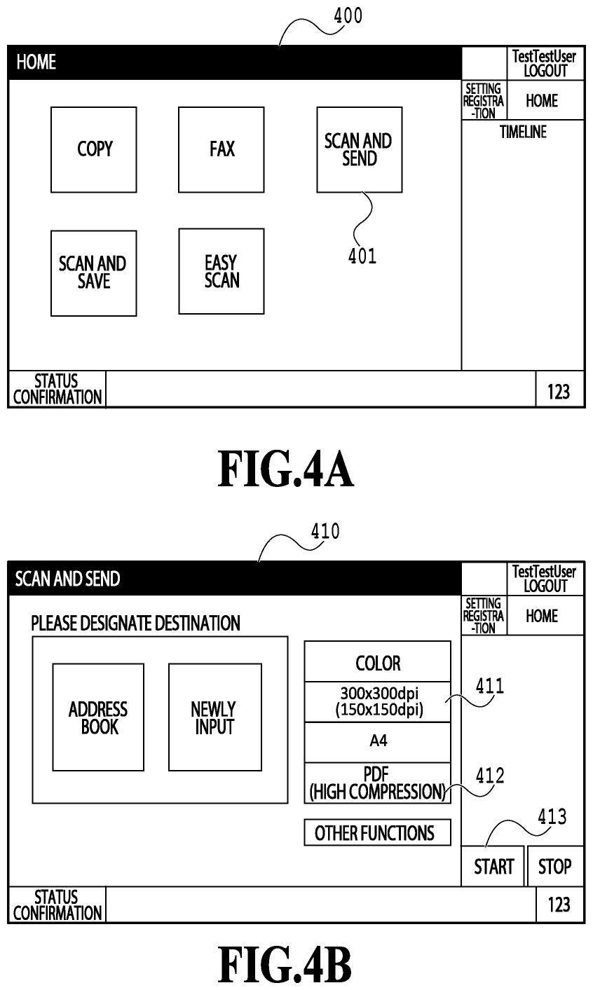

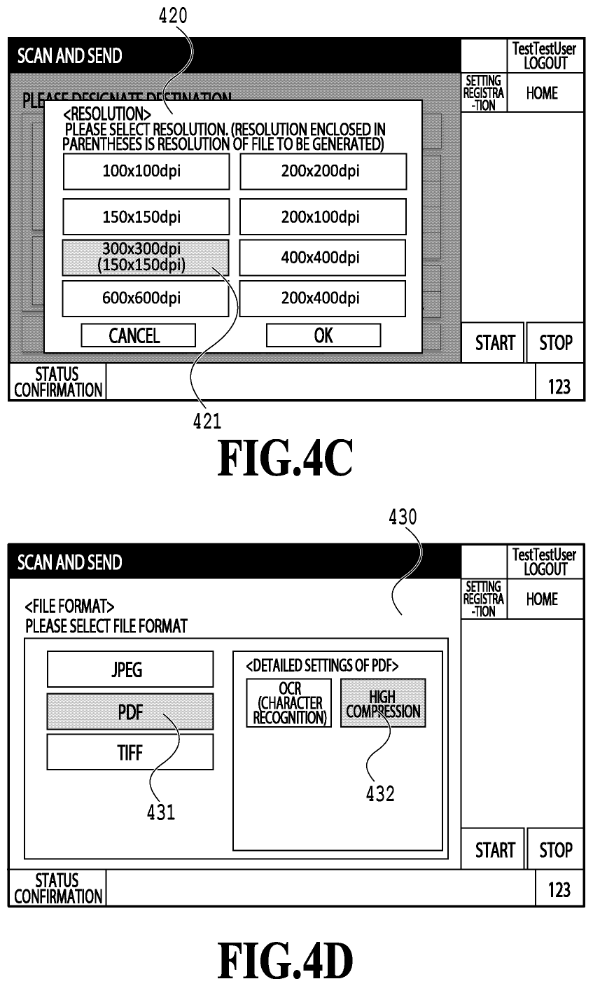

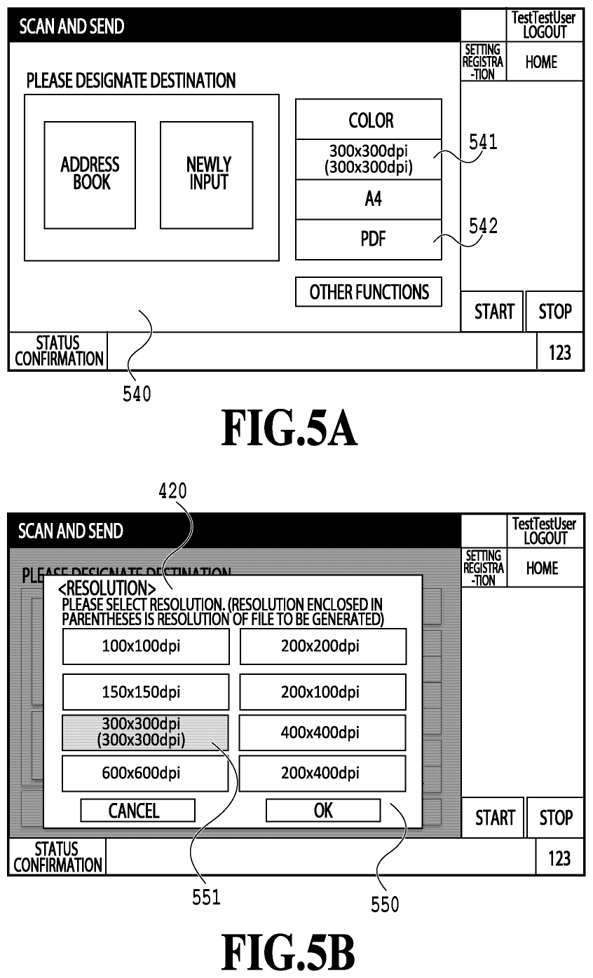

FIGS. 4A, 4B, 4C, and 4D, and FIGS. 5A and 5B are diagrams showing an example of screens displayed on the operation unit 220 in the present embodiment. The screens shown by FIGS. 4A, 4B, 4C, and 4D, and FIGS. 5A and 5B are displayed by the screen display control unit 301. FIG. 4A shows an example of a home screen 400. An icon configured to use the aforementioned application 304 is arranged on the home screen 400. The home screen 400 of FIG. 4A is displayed in a case where the MFP 101 is activated and in response to a home button being depressed by the user in the other screens. In the present embodiment, an embodiment using a scan and send application is explained as an example of the application 304 using the scanner 222.

FIG. 4B shows an example of a basic setting screen 410 in a case of the use of the scan and send application. The basic setting screen 410 of FIG. 4B is displayed on the operation unit 220 in response to a scan and send button 401 of FIG. 4A being depressed by the user. A button (area) configured to perform the reading setting, for example a resolution setting button 411 and a file format setting button 412, is provided on the basic setting screen 410. In addition, the basic setting screen 410 of FIG. 4B is provided with buttons designating a color setting, a paper setting, and other functions or the like. The present embodiment mainly centers on and explains a case where the resolution setting button 411 and the file format setting button 412 are depressed, and therefore an explanation about other buttons is omitted.

The MFP 101 of the present embodiment is configured to carry out a high compression process after an image is read at a resolution of a parameter preset by the user in a case where the high compression process is enabled in a high compression setting button 432 of FIG. 4D described later. Specifically, in the MFP 101, a process for compressing only a background area in the image data of a read image at a lower resolution than a resolution of reading and generating a file is performed. In other words, a part of the image data is compressed at a parameter which is not a parameter (resolution) preset by the user. In the present embodiment, the resolution setting button 411 of the basic setting screen 410 in FIG. 4B displays a plurality of parameters. That is, the resolution setting button 411 displays both “300×300 dpi” which is a parameter of the resolution preset by the user and “(150×150 dpi)” which is a parameter of the resolution in a case where a part of image data is compressed by the high compression process. In this example, “300×300 dpi” is a parameter of the image reading, and “(150×150 dpi)” is a parameter of a file to be generated. Thus, in the present embodiment, in a case where the parameter of the image reading is different from the parameter of the file generation, a process for displaying the former parameter along with the latter parameter is performed. Thereby, the user can appropriately recognize the parameter of the file generation even in a state where the parameter of the reading differs from the parameter of the file generation in a case where the user sets the parameter of the reading. Incidentally, as a method for extracting a background area in the image data, a process for segmenting the image data into a character area and the background area by performing an image area segmentation process on scanned image data is given as an example. In addition, any method is used as the method for extracting the background area from the image data.

FIG. 4C shows an example of the resolution setting screen 420. The resolution setting screen 420 of FIG. 4C is displayed on the operation unit 220 in response to the resolution setting button 411 of FIG. 4B being depressed by the user. On the resolution setting screen 420, a list of resolution selection buttons including a setting button 421 corresponding to 300×300 dpi is provided, and corresponding resolutions are displayed on respective resolution setting buttons. The resolution selection button is a button configured to be able to select any resolution from a plurality of resolutions provided in the MFP 101 in advance. The resolution setting screen 420 of FIG. 4C basically displays a resolution (parameter) of the image reading. Further, in a case where the resolution of the file generation is an item (300×300 dpi) which is different from the resolution of the image reading, as mentioned above, the resolution of the image reading is displayed along with the resolution of the file generation. In FIG. 4C, only 300×300 dpi is the item in which the resolution of the image reading is different from the resolution of the file generation, and in the item of 300×300 dpi, the resolution of the file generation (150×150 dpi) is also displayed. Further, the resolution setting screen 420 of FIG. 4C additionally displays a message which makes a notification that a resolution enclosed in parentheses is the resolution of a file to be generated. Incidentally, the resolution setting screen 420 may have a configuration in which the message which makes a notification that the resolution enclosed in parentheses is the resolution of the file to be generated is not displayed. Incidentally, it also can be said that the resolutions of the file generation are displayed in the resolution setting screen 420 because the resolution of the image reading and the resolution of the file generation have the same value with respect to items other than 300×300 dpi.

The resolution setting screen 420 in FIG. 4C returns to the basic setting screen 410 of FIG. 4B by the user selecting a parameter of the resolution of the image reading and depressing an OK button. In the basic setting screen 410 displayed again, a parameter of a selected resolution is displayed on the resolution setting button 411. After that, in a case where the start button 413 is depressed by the user, scanning processing is executed based on the selected resolution (parameter).

Incidentally, as mentioned above, in the MFP 101 of the present embodiment, the high compression process is performed in a case where the high compression process is enabled in the high compression setting button 432 of FIG. 4D described later. In other words, after an image is read at the resolution (parameter) preset by the user, the high compression process is carried out. In the high compression process, only a back ground area in the image data of the read image is compressed at a lower resolution than the resolution of the reading and thus high compressed file is generated. In other words, a part of image data is compressed at a parameter which is not a parameter preset by the user. Thus, in the setting button 421 corresponding to 300×300 dpi, both “300×300 dpi” and “(150×150 dpi)” are displayed. “300×300 dpi” is a parameter preset by the user. “(150×150 dpi)” is a parameter in a case where a part of image data is compressed by the high compression process. Incidentally, in the MFP 101, the high compression process may be enabled in a default setting. Even in a case of the default setting, “300×300 dpi” which is indicated as an example is a parameter preset by the user likewise.

FIG. 4D shows an example of the file format setting screen 430. On the file format setting screen 430, file format setting buttons including a PDF setting button 431 are provided. Corresponding file format values are described on respective file format setting buttons. Further, in a case of the selection of the respective file format setting buttons, a corresponding detailed setting button (for example, the high compression setting button 432) is displayed. Enablement (the high compression setting is ON) or disablement (the high compression setting is OFF) of the high compression process can be set by depressing the high compression setting button 432. In a case where the high compression process is enabled, a display indicating that the high compression process is enabled is produced, and in a case where the high compression process is disabled, a display indicating that the high compression process is disabled is produced. For example, in a case where the high compression process is enabled, the indication is highlighted as in the high compression setting button 432 in FIG. 4D, and in a case where the high compression process is disabled, the indication is not highlighted.

FIG. 5A shows an example of the basic setting screen 540 in a case where the high compression setting is made OFF. In a case where the high compression setting is OFF, resolution reduction does not occur in a case of the file generation. Thus, the resolution enclosed in parentheses of a resolution setting button 541 is denoted in the same resolution (300×300 dpi) as a notation outside the parentheses which is the resolution of the image reading. Further, in the file format setting button 542, the words “high compression” enclosed in parentheses are not denoted, but the word “PDF” is denoted. Thus, in the present embodiment, with respect to a parameter in which the resolution of the file generation can be different from the resolution of the image reading, even though the high compression setting is OFF, a process for displaying both parameters side by side is performed.

FIG. 5B shows an example of the resolution setting screen 550 in a case where the high compression setting is OFF. As in FIG. 5A, in a case where the high compression setting is OFF, resolution reduction does not occur in a case of the file generation. Thus, the resolution enclosed in parentheses of a setting button 551 corresponding to 300×300 dpi is denoted in the same resolution (300×300 dpi) as the notation outside the parentheses which is the resolution of the image reading.

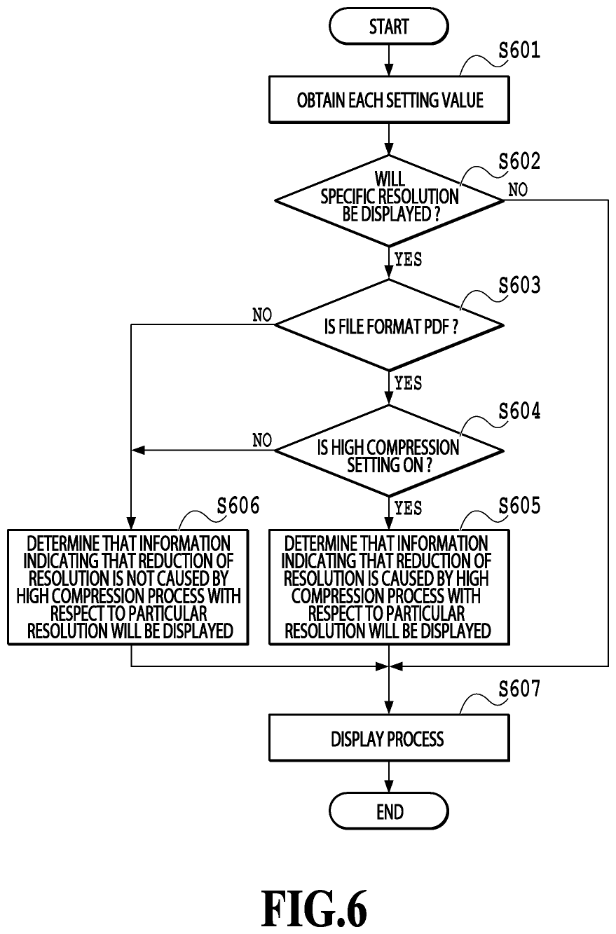

FIG. 6 is a flow chart showing a display process of a screen including a resolution setting. The process of the flow chart of FIG. 6 is implemented by the CPU 211 of the MFP 101 reading a program configured to implement control modules stored in the ROM 212 into the RAM 213 and executing the program. Incidentally, a part or all of the functions of steps in FIG. 6 may be implemented by hardware such as ASIC or an electronic circuit. The symbols “S” in explanations of each process mean steps in each of the flow chart diagrams (hereinafter, the same applies in the flow chart diagrams in the present specification).

The process of the flow chart of FIG. 6 starts based on the scan and send button 401 in the home screen 400 of FIG. 4A being depressed by the user. Further, the process of the flow chart of FIG. 6 starts based on the resolution setting button 411 in the basic setting screen 410 of FIG. 4B being depressed by the user. That is, this is a process which is performed in a case where the basic setting screen 410 of FIG. 4B is displayed based on the scan and send button 401 being depressed and in a case where the resolution setting screen 420 of FIG. 4C is displayed based on the resolution setting button 411 being depressed. Incidentally, a trigger which starts a process of the flow chart of FIG. 6 is not limited to the above example, and the process of the flow chart of FIG. 6 may be triggered by the user operation in which screen transition illustrated in FIGS. 4B to 4D and FIGS. 5A and 5B is performed. The process of FIG. 6 is a process of a flow chart extracting a portion focusing on display contents of the resolution setting.

In S601, the screen display control unit 301 reads out setting values of a resolution setting which is currently selected, a file format setting, and a high compression setting from the RAM 213. After the setting values are read out, the screen display control unit 301 proceeds to S602.

In S602, the screen display control unit 301 determines whether to display an item at a particular resolution in a screen to transit to. Here, the particular resolution indicates a resolution which can be reduced by the high compression process. Specifically, in an example of FIGS. 4A, 4B, 4C and 4D, a particular resolution means a resolution of 300×300 dpi. In a case where it is determined that the item at the particular resolution will be displayed, the screen display control unit 301 proceeds to S603. In a case where it is determined that the item at the particular resolution will not be displayed, the image display control unit 301 proceeds to S607.

In S603, the screen display control unit 301 determines whether a currently selected file format is PDF or not by the use of the setting values read out at S601. In a case where it is determined that the currently selected file format is PDF, the image display control unit 301 proceeds to S604. In a case where it is determined that the currently selected file format is not PDF, the screen display control unit 301 proceeds to S606.

In S604, the screen display control unit 301 determines whether the high compression setting is enabled or not. In a case where it is determined that the high compression setting is enabled, the screen display control unit 301 proceeds to S605. In a case where it is determined that the high compression setting is not enabled, that is, is disabled, the screen display control unit 301 proceeds to S606.

In S605, the screen display control unit 301, with respect to a particular resolution, determines that information indicating that the resolution is reduced by the high compression process will be displayed. The display of information indicating that the resolution is reduced by the high compression process means information display as in the resolution setting button 411 of FIG. 4B and the setting button 421 corresponding to 300×300 dpi of FIG. 4C. In other words, S605 is a process in which the screen display control unit 301 determines that a parameter (resolution) displayed in parentheses of the resolution selection buttons will be displayed by using a parameter of the execution of the high compression process, not a parameter of the image reading. As shown in FIG. 4B, both a parameter of “300×300 dpi” preset by the user and a parameter of “(150×150 dpi)” in a case where a part of the image data is compressed by the high compression process are displayed on the resolution setting button 411. Further, as in FIG. 4C, “300×300 dpi” which is the parameter of the resolution preset by the user is displayed on the setting button 421 corresponding to 300×300 dpi. Further, in addition, “(150×150 dpi)” which is a parameter in a case where a part of the image data is compressed by the high compress process is displayed. The user can recognizes by checking the parameter that the resolution is reduced by the high compression process. Further, as shown in FIG. 4C, a message which explains the meaning of the parameter enclosed in parentheses is included in the resolution setting screen 420, and thus the user can recognize that the resolution is reduced by the high compression process. Incidentally, the contents of the message may not be described in FIG. 4C. Furthermore, the screen display control unit 301 may be configured to display the message explaining the meaning of the parameter enclosed in parentheses of the resolution in the basic setting screen 410 of FIG. 4B. In S605, the screen display control unit 301 determines that such a display will be performed, and after S605, the screen display control unit 301 proceeds to S607.

In S606, the screen display control unit 301 determines that information indicating that the reduction of a resolution is not caused by the high compression process will be displayed. The display of information indicating that the reduction of the resolution is not caused by the high compression process means information display as in the resolution setting button 541 of FIG. 5A and the setting button 551 corresponding to 300×300 dpi of FIG. 5B. That is, S606 is a step in which the screen display control unit 301 determines that a parameter displayed within parentheses of the resolution selection button will be displayed by using the parameter of the image reading. As in FIG. 5A, both “300×300 dpi” which is the parameter of the resolution preset by the user and “(300×300 dpi)” which is the same parameter as “300×300 dpi” are displayed on the resolution setting button 541. Further, as in FIG. 5B, both “300×300 dpi” which is the parameter of the resolution preset by the user and “(300×300 dpi)” which is the same parameter as “300×300 dpi” are displayed on the setting button 551 corresponding to 300×300 dpi. The user can recognize by checking the parameters that the reduction of the resolution is not caused by the high compression process. In S606, the screen display control unit 301 determines such display will be performed, and after S606, the screen display control unit 301 proceeds to S607.

In S607, the screen display control unit 301 performs a display process. The display process in S607 includes the display determined in S604 or S605. That is, with respect to an item of a particular resolution, the display determined in S604 or S605 is performed. An item of a resolution other than the particular resolution is displayed in the form of a normal display, that is, an item of a resolution not enclosed in parentheses is displayed. Thus, in S607, a process in which a screen to be displayed is displayed by depressing a button of the screen transition which triggers the process of this flow chart is performed. For example, in a case where a process of the flow chart of FIG. 6 is performed in response to the scan and send button 401 being depressed by the user, the screen shown in FIG. 4B or FIG. 5A is displayed according to the determination of S604 or S605. Similarly, in a case where the process of the flow chart of FIG. 6 is performed in response to the resolution setting button 411 being depressed by the user, the screen shown in FIG. 4C or FIG. 5B is displayed according to the determination of S604 or S605. After the process of S607, the screen display control unit 301 ends the process of the flow chart shown in FIG. 6.

Thus, in the flow chart of FIG. 6, control of causing the operation unit 220 to perform display is performed by switching between a first notation and a second notation according to a condition in a case of the generation of a file of a document image to be read by the scanner. In the example of FIG. 6, a condition in a case of the generation of the file corresponds to a condition that the file format is PDF and whether the high compression setting is ON or not. In a case where the file format is not PDF, or in a case where the high compression setting is OFF, the first notation which denotes information indicating that the reduction of the resolution caused by the compression process does not occur is performed. In contrast, in a case where the file format is PDF and the high compression setting is ON, the second notation which denotes information indicating that the resolution is reduced by the compression process is performed. Specifically, in the first notation, a notation in which the same resolutions are displayed side by side is performed; in the second notation, a notation in which different resolutions are displayed side by side is performed.

Incidentally, in the present embodiment, as an example of the particular resolution, that is, an example of a parameter whose resolution can be reduced by the high compression process, 300×300 dpi is shown and an explanation is made. However, the parameter may be another parameter. For example, in a case where 400×400 dpi is selected, in a case where the high compression process is performed in the MFP 101, not 300×300 dpi but 400×400 dpi may be displayed along with the resolution enclosed in parentheses. Further, in a case of a plurality of parameters whose resolution can be reduced by the high compression process, the plurality of parameters may be displayed along with resolutions enclosed in parentheses. Incidentally, the parameter whose resolution can be reduced by the high compression process is prescribed in the MFP 101 in advance.

Further, in the present embodiment, an example in which there are a plurality of resolutions which can be set and a part of the plurality of resolutions are the particular resolutions which can be reduced by the high compression process is explained. However, there may be a plurality of resolutions which can be set and all the plurality of resolutions may be particular resolutions which can be reduced by the high compression process. In this case, the process of S602 may be skipped, and the screen display control unit 301 may perform a process so that the process proceeds to S603 after S601.

As mentioned above, according to the present embodiment, the user can appropriately recognize the parameter of the file generation. In other words, the user can appropriately recognize the parameter of the file generation even if the parameter of the image reading and the parameter of the file generation have different values in a case where the user sets the parameter of the image reading. For example, in the present embodiment, in a case where the MFP 101 displays the basic setting screen 410 (FIG. 4B) and the resolution setting screen 420 (FIG. 4C), the MFP 101 can display a resolution in a notation including resolution information obtained in consideration of a state of a relevant setting (here, a high compression setting). Thereby, the user can check, on a setting screen, the resolution of the image reading and the resolution of the file generation obtained in consideration of the relevant setting. Accordingly, it is possible to inhibit the user from mistakenly generating a file at an unintended resolution.

Incidentally, the aforementioned embodiment is explained by giving the scan and send application as an example. Here, in a case where the application 304 used by the user is not the scan and send application, the process explained in the present embodiment may not be applied. In other words, the process of the flow chart of FIG. 6 may be a process which is applied in a case where a particular application is executed. For example, in an easy scan application having a similar function to the scan and send application, the detailed number of a resolution is not displayed. Specifically, in a case where resolution is displayed in the easy scan application, display is performed by using an aspect such as “file size small” or “high definition.” Thus, the present embodiment may not be applied in an application which does not display detailed information to the user. In addition, similarly, the present embodiment may not be applied in an application which does not need to change a display such as an application in which the difference between the parameter of the image reading and the parameter of the file generation is not caused.

### Second Embodiment

In the first embodiment, an example in which the resolution of the image reading is displayed along with the resolution of the file generation is explained. Further, as shown in FIGS. 5A and 5B, in the first embodiment, an example in which even if there is no difference between the resolution of the image reading and the resolution of the file generation, both resolutions are displayed is explained. However, in such a case, it is possible that the user rather gets confused because too much information which does not have to be considered is displayed on the setting screen.

Then, in a second embodiment, an example in which the resolution of the file generation is not displayed in a case where there is no difference between the resolution of the image reading and the resolution of the file generation is explained. Incidentally, in a case where there is no difference between the resolution of the image reading and the resolution of the file generation, both resolutions have the same value, and a target to be displayed may be either of the resolution of the image reading or the resolution of the file generation. That is, the following explains an example in which the resolution of the file generation is not displayed in a case where there is no difference between the resolution of the image reading and the resolution of the file generation, but this may be treated as an example in which the resolution of the image reading is not displayed.

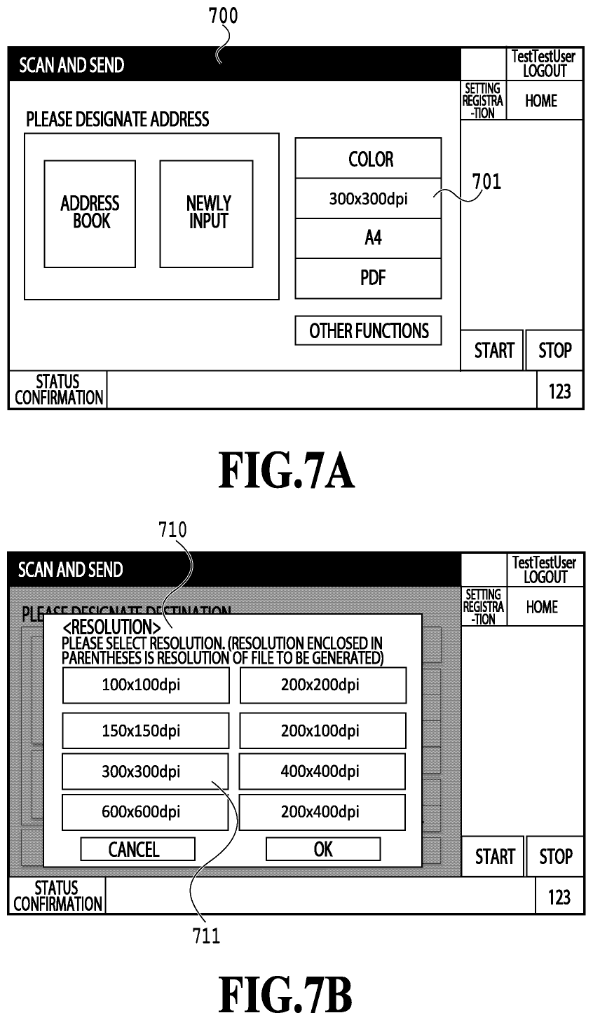

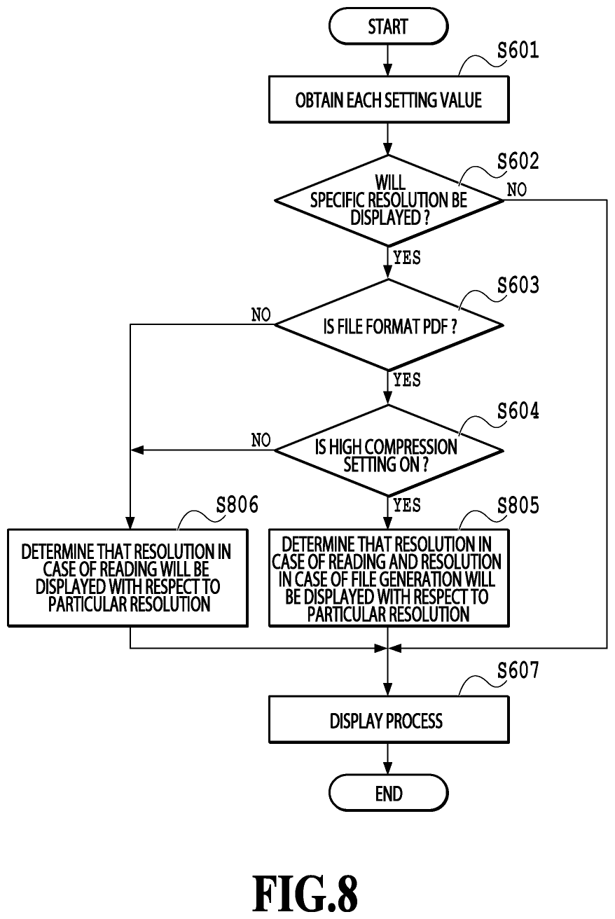

A basic configuration of the present embodiment is similar to the example explained in the first embodiment, and thus an explanation thereof is omitted. The following mainly explains and focuses on the difference between the second embodiment and the first embodiment. The differences between the present embodiment and the first embodiment are the following: FIG. 5A and FIG. 5B are changed to FIG. 7A and FIG. 7B; and the flow chart of FIG. 6 is changed to the flow chart of FIG. 8. Incidentally, in the present embodiment, a particular resolution at which the resolution can be reduced by the high compression process is explained based on the example in which the resolution is 300×300 dpi as in the first embodiment.

FIGS. 7A and 7B are diagrams showing an example of a screen displayed on the operation unit 220 in the present embodiment. FIG. 7A shows an example of a basic setting screen 700 in a case where the high compression setting is set to be OFF in the present embodiment. No difference is caused between the resolution of the image reading and the resolution of the file generation because the high compression setting is OFF. Thus, the screen display control unit 301 displays 300×300 dpi which is the resolution of the image reading and which is the parameter of the resolution of the file generation on a resolution setting button 701. In other words, the screen display control unit 301 only displays the parameter of the resolution of the image reading on the resolution setting button 701. In contrast, in a case where the high compression setting is ON, the difference is caused between the resolution of the image reading and the resolution of the file generation. Thus, as in the basic setting screen 410 of FIG. 4B explained in the first embodiment, the screen display control unit 301 displays information indicating both 300×300 dpi which is the resolution of the image reading and 150×150 dpi which is the resolution of the file generation. That is, as in the basic setting screen 410 of FIG. 4B, “300×300 dpi (150×150 dpi)” is displayed on the resolution setting button 411.

FIG. 7B shows an example of the resolution setting screen 710 in a case where the high compression setting is made OFF in the present embodiment. No difference is caused between the resolution of the image reading and the resolution of the file generation because the high compression setting is OFF. Thus, the screen display control unit 301 displays 300×300 dpi which is the resolution of the image reading and the parameter of the resolution of the file generation on a setting button 711 corresponding to 300×300 dpi. In other words, the screen display control unit 301 only displays the parameter of the resolution of the image reading on the setting button 711 corresponding to 300×300 dpi. In contrast, in a case where the high compression setting is ON, the difference is caused between the resolution of the image reading and the resolution of the file generation. Thus, as in the resolution setting screen 420 of FIG. 4C explained in the first embodiment, the image display control unit 301 displays information indicating both 300×300 dpi which is the resolution of the image reading and 150×150 dpi which is the resolution of the file generation. That is, as in the resolution setting screen 420 of FIG. 4C, “300×300 dpi (150×150 dpi)” is displayed on the setting button 421 corresponding to 300×300 dpi. Incidentally, in FIG. 7B, a massage saying “the resolution enclosed in parentheses is the resolution of the file to be generated” is displayed as a text. This message may be configured not to be displayed in a case where there is no notation in parentheses.

FIG. 8 is a flow chart showing a display process of a screen including resolution settings. The trigger which starts the process of the flow chart of FIG. 8 is similar to the example explained in FIG. 6. The difference between the flow chart of FIG. 8 and the flow chart of FIG. 6 is the following: S605 and S606 are changed to S805 and S806. Other processes are similar to the examples explained in the first embodiment, and thus an explanation thereof is omitted.

In S805, with respect to a particular resolution, the screen display control unit 301 determines that the resolution of the image reading and the resolution of the file generation will be displayed. In other words, as shown in FIG. 4B or FIG. 4C, it is determined that both the resolution of the image reading and the resolution of the file generation will be displayed because the difference between the resolution of the image reading and the resolution of the file generation is caused by the high compression process. Further, as explained in FIG. 6, this step proceeds to S607.

In S806, with respect to the particular resolution, the screen display control unit 301 determines that the resolution of the image reading will be displayed. That is, the resolution of the image reading is equal to the resolution of the file generation because the high compression process is not performed. Therefore, only display of one piece of information (the resolution of the image reading in this example) is performed. Further, as explained in FIG. 6, this step proceeds to S607.

Thus, in the flow chart of FIG. 8, control of switching between the first notation and the second notation and causing the operation unit 220 to perform display is performed according to a condition in a case of the generation of the file of the document image to be read by the scanner. In the example of FIG. 8, the condition in a case of the generation of the file corresponds to whether the file format is PDF and the high compression setting is ON. In a case where the file format is not PDF, or the high compression setting is OFF, the first notation which denotes the reading parameter in a case where the document image is read by the scanner is performed. In contrast, in a case where the file format is PDF and the high compression setting is ON, the second notation which denotes a notation including the generation parameter of the file and the reading parameter is performed.

As explained above, based on the present embodiment, the MFP 101 can display only one piece of information (in this example, the resolution of the reading) in a case where no difference is caused between the resolution of the image reading and the resolution of the file generation. This can reduce information presented to the user in a case of setting and suppress confusion caused by unnecessary information for the user. Further, in contrast, in the present embodiment, in a case where a difference is caused between the resolution of the image reading and the resolution of the file generation, both resolutions are displayed. The user thereby can understand the parameter of the file generation even in a state where the parameter of the reading and the parameter of the file generation are different from each other in a case where the user sets the parameter of reading.

### Third Embodiment

In the first embodiment and the second embodiment, an example in which in a case where the difference is caused between the resolution of the image reading and the resolution of the file generation by the high compression setting, the notation of the resolution is changed is explained. Thus, in a case where the user changes the resolution setting in a state where both resolution of the image reading and resolution of the file generation are displayed, it is considered that it is highly possible that the resolution of the file to be generated is a resolution which is unintended by the user. In view of such a case, in the present embodiment, an example in which the high compression setting is changed in a case where the user changes the setting of a resolution which is currently set is explained.

As an example, assume that the high compression setting is ON at a default setting of the MFP 101. In such a case, for example, assume that the user who has checked the basic setting screen 410 of FIG. 4B determines that the resolution of the file generation is not a resolution which the user desires and changes the resolution setting. The user changing the resolution setting means that the resolution setting is not a resolution setting which is intended by the user, and it is assumed that a cause thereof is the high compression setting being ON. Therefore, in the present embodiment, in a case where the change of the resolution setting made by the user is accepted, a process for making the high compression setting OFF is performed.

An explanation about a basic configuration of the present embodiment is omitted because the basic configuration is similar to the example explained in the first embodiment or the second embodiment, and an explanation centering on a difference is made.

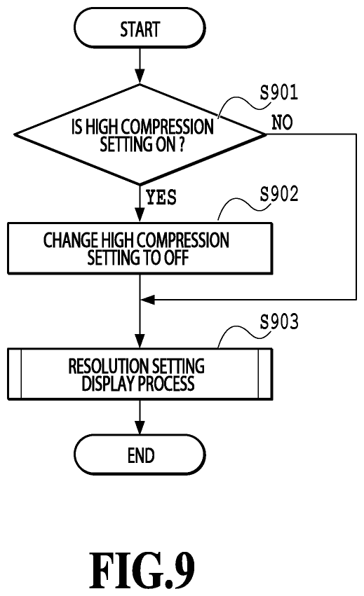

FIG. 9 is a flow chart of a process in a case where the user operation to change the resolution setting is accepted. That is, the process of FIG. 9 is triggered by, for example, the acceptance of the user operation to change the resolution setting after the screen display control unit 301 displays the resolution setting screen 420 as in FIG. 4C. In this example, the process is executed at a timing at which the OK button is depressed after the selection of a desired resolution made by the user in FIG. 4C is accepted and the screen returns to the basic setting screen 410 of FIG. 4B. Incidentally, another example may be an aspect in which the OK button does not exist in the resolution setting screen 420 and the screen transition is triggered by the selection of the item of the resolution made by the user.

In S901, the screen display control unit 301 determines whether the high compression setting is ON or not. In a case where it is determined that the high compression setting is ON, the screen display control unit 301 proceeds to S902. In a case where it is determined that the high compression setting is OFF, the screen display control unit 301 proceeds to S903.

In S902, the screen display control unit 301 changes the high compression setting to OFF and proceeds to S903 after that.

In S903, the screen display control unit 301 performs the resolution setting display process. S903 corresponds to the process of FIG. 6 explained in the first embodiment or the process of FIG. 8 explained in the second embodiment, and thus an explanation thereof is omitted.

Thus, in a case where the user operation to change the resolution setting is accepted in the resolution setting screen 420 as in FIG. 4C, screen transition is performed in a state where the high compression setting is changed to OFF. Accordingly, in the process of S903, as in FIG. 5A and FIG. 5B, information indicating that the reduction of the resolution caused by the high compression process does not occur is displayed on the resolution setting button, or the resolution of the image reading is displayed on the resolution setting button by the process of S903 as in FIG. 7A and FIG. 7B.

Incidentally, after that, in a case where the user reconsiders and wants to make the high compression setting ON, as explained in the first embodiment, in the file format setting screen 430 of FIG. 4D, the user depresses the high compression setting button 432. In subsequent screen transition, the process of FIG. 6 of the first embodiment or the process of FIG. 8 of the second embodiment is performed.

As explained above, in the present embodiment, in a case where the user changes the resolution, a relevant high compression setting can be temporarily changed to OFF. This can suppress the generation of a file at an unintended resolution with the high compression setting remaining in a case where the user changes the resolution.

Incidentally, in the present embodiment, the process in which the high compression setting is made OFF in a case where the high compression setting is set to ON is shown, but the present disclosure is not limited to this. For example, in a case where the high compression setting is set to ON, the resolution setting may be changed to a particular setting value. Incidentally, the particular setting value is a parameter which exceeds a predetermined threshold. For example, a predetermined threshold is 200×200 dpi. Further, in such a case where the high compression setting is set to ON, in a change process in a case where the resolution setting is changed to the particular setting value, the present embodiment may be configured not to perform the process of FIG. 9.

### Fourth Embodiment

In the first embodiment and the second embodiment, an example in which the notation of the resolution corresponding to the high compression setting is changed according to the compression setting is explained. Here, there is a case where the high compression setting is further influenced by another setting value in addition to the setting of ON or OFF. For example, there is a case where a definition is put to a compression ratio, and in a case where the high compression setting is ON, there is a case where the compression of a file is carried out based on the set compression ratio. In such a case, even though the notation of the resolution based on the high compression setting is included in the setting screen, the user cannot find why the resolution of the file generation is a displayed value. Further, it can be considered that there is a case where the user cannot notice that a setting as in the above compression ratio exists in the first place. Then, in the preset embodiment, an example in which the display of the resolution includes information of the compression ratio is explained.

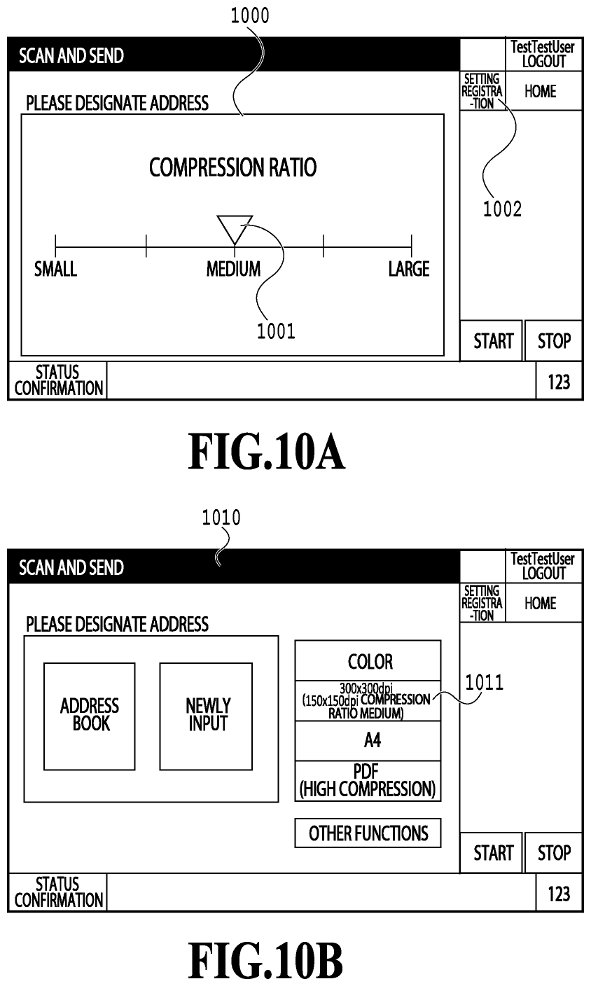

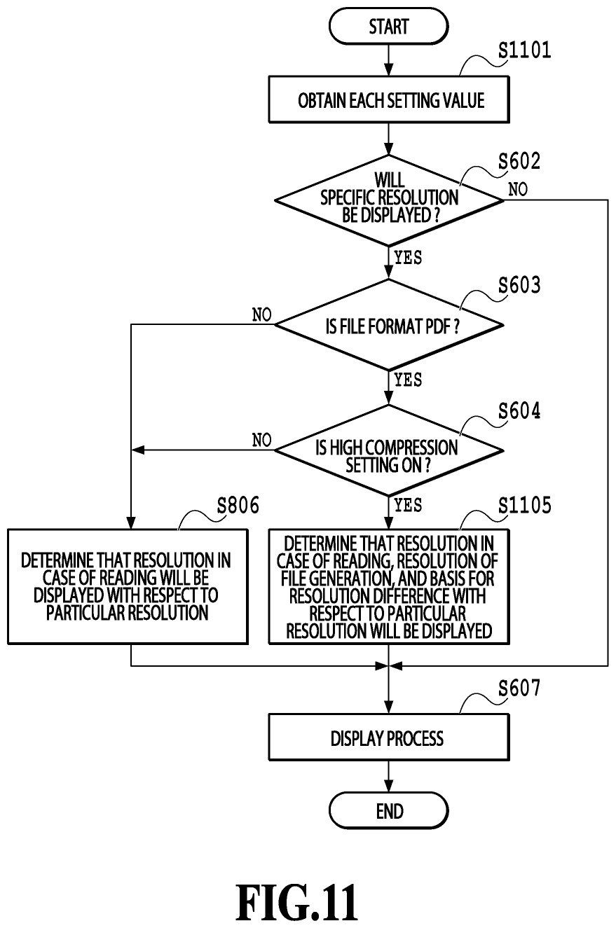

A basic configuration of the present embodiment is similar to an example explained in the first embodiment or the second embodiment, and thus an explanation thereof is omitted, and an explanation centering on a difference is made. The following concentrates on and explains the difference between the present embodiment and the second embodiment. The differences between the present embodiment and the second embodiment are the following: FIG. 10A is added; FIG. 4B is changed to FIG. 10B; and the flow chart of FIG. 8 is changed to FIG. 11. Incidentally, the present embodiment may be combined with the third embodiment.

FIGS. 10A and 10B are diagrams showing an example of a screen displayed in the operation unit 200 in the present embodiment. FIG. 10A shows an example of a compression ratio setting screen 1000. A slider 1001 is provided in the compression ratio setting screen 1000, and the user can designate a compression ratio by moving the slider 1001. The compression ratio is an adjustment parameter adjusting the degree of compression. Incidentally, such a method for accepting the selection of the compression ratio is not limited to the slider 1001. A box to which a numerical value is input may be provided to accept the input by the user. Further, a plurality of buttons may be provided to accept the selection of the compression ratio by a button selection. Notations of Large, Medium, and Small are used as a definition of stages of the compression ratio in the example of FIG. 10A, but the present disclosure is not limited to the aspect. Incidentally, the compression ratio setting screen 1000 is displayed by depressing a setting registration button 1002.

FIG. 10B shows an example of the basic setting screen 1010 in the present example. In a case where the compression ratio is set to “Medium,” the resolution setting button 1011 has a notation of 300×300 dpi. Further, the resolution setting button 1011 includes the notation “(150×150 dpi)” indicating a resolution after the compression and the notation “Compression Ratio Medium.” Incidentally, for example, in a case where the compression ratio is set to “Small,” “(200×200 dpi Compression Ratio Small)” is displayed, and in a case where the compression ratio is set to “Large,” “(100×100 dpi Compression Ratio Large)” is displayed. Incidentally, an explanation is made by giving the basic setting screen as an example here, but a similar notation is denoted in the resolution setting screen.

FIG. 11 is a flow chart showing a display process of a screen including the resolution setting. The start of the process of the flow chart of FIG. 11 is triggered in a similar way to the example explained in FIG. 8. The difference between the flow chart of FIG. 11 and the flow chart of FIG. 8 is the following: S601 and S805 are changed to S1101 and S1105, respectively. Other processes are similar to the examples explained in the second embodiment.

In S1101, the screen display control unit 301 reads the setting value of the compression ratio in addition to the currently selected resolution setting, file format setting, and high compression setting from the RAM 213. After reading the setting value, the step proceeds to S602.

In S1105, with respect to a particular resolution, the screen display control unit 301 determines that the resolution of the image reading, the resolution of the file generation, and a basis for a resolution difference (the compression ratio in this example) will be displayed on the operation unit 220. After that, the step proceeds to S607.

Incidentally, a display aspect is not limited to the aforementioned example. For example, in a case where the compression ratio is denoted as in the present embodiment, control may be performed so that the resolution of the file generation is not displayed. Further, in FIG. 11, the difference between the present embodiment and the second embodiment is explained by way of example, but the process may be based on FIG. 6 explained in the first embodiment. That is, S601 and S605 in FIG. 6 may be changed to S1101 and S1105 of FIG. 11, respectively.

As explained above, in the present embodiment, the user can simultaneously check information on the compression ratio which serves as a basis for the resolution of the file generation. The user thereby can formulate a change policy in a case where a setting value is changed to a setting value intended by the user. For example, in the present embodiment, the user can understand that the compression ratio can be set. Further, the user can find that a resolution setting intended by the user can be implemented by changing the compression ratio.

### Other Embodiments

In the aforementioned embodiments, an explanation is made based on an example in which the control unit 210 of the MFP 101 controls the contents displayed on the operation unit 220 of the MFP 101. That is, an example in which the MFP 101 functions as a control apparatus is explained. However, the embodiments are not limited to this example. A host PC which controls the MFP 101 from the outside may be additionally provided, and processes similar to the processes of the aforementioned embodiments may be performed in the host PC. That is, the control apparatus may be an external apparatus which is different from the MFP 101.

Further, as explained in the first embodiment, the particular resolution may be one or more particular resolutions in the aforementioned processes of the embodiments. Furthermore, the particular resolution may correspond to all the resolutions which can be set.

Further, the aforementioned embodiments explain examples in which the compression of a background part is performed in a case where the file format is PDF and the high compression setting is ON. However, the present disclosure is not limited to these examples, and any embodiment may be applicable as long as a combination of a file format and a setting is such that a resolution of the image reading can be different from a resolution of the file generation.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, usability in a case of the file generation for users can be improved.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-105854, filed Jun. 28, 2023, which is hereby incorporated by reference wherein in its entirety.

What is claimed is:

1. A control apparatus for controlling a scanner comprising:
a display unit; and
a control unit configured to execute display control to display a reading parameter used for reading a document image by the scanner on the display unit in a case where a file of the document image is to be generated on a first condition, and to display both a generation parameter used for generating the file and the reading parameter on the display unit in a case where the file is to be generated on a second condition being different from the first condition.

2. The control apparatus according to claim 1, wherein the first condition includes a compression setting which is a setting in a case where image data of the document image is compressed being disabled, and
wherein the second condition includes the compression setting being enabled.

3. The control apparatus according to claim 2, wherein the control unit displays the generation parameter, the reading parameter, and a basis for the generation parameter on the display unit in a case where the file is to be generated on the second condition.

4. The control apparatus according to claim 3, wherein the control apparatus can set an adjustment parameter adjusting a compression ratio in a case where the compression setting is enabled, and wherein
the control unit displays information on the adjustment parameter as the basis for the generation parameter on the display unit.

5. The control apparatus according to claim 1, wherein the reading parameter is a parameter selected from a plurality of parameters, and wherein the control unit executes the display control on a particular parameter included in the plurality of parameters.

6. The control apparatus according to claim 5, wherein the particular parameter is a parameter by which a part of an area of the document image is compressed in a case where a compression setting is enabled.

7. The control apparatus according to claim 1, wherein the reading parameter is a parameter selected from a plurality of parameters, and wherein the control unit executes the display control on all parameters of the plurality of parameters.

8. The control apparatus according to claim 1, wherein the control unit disables a compression setting being a setting used for compressing image data of the document image in a case where a change of the reading parameter currently set is accepted.

9. The control apparatus according to claim 1, wherein the reading parameter and the generation parameter are resolutions.

10. The control apparatus according to claim 1, wherein the control unit executes the display control based on an acceptance of an instruction of transitioning to a screen displaying a resolution currently set or a screen in which a resolution is selected.

11. A control apparatus for controlling a scanner comprising:
a display unit; and
a control unit configured to execute display control to display, on the display unit, information indicating that a resolution is not reduced by a compression process in which image data of a document image is compressed in a case where a file of the document image read by the scanner is to be generated on a first condition and to display, on the display unit, information indicating that reduction of the resolution caused by the compression process occurs in a case where the file is to be generated on a second condition being different from the first condition.

12. The control apparatus according to claim 11, wherein, in a case where the file is to be generated on the first condition, the same resolution is displayed as a reading parameter used for reading the document image by the scanner and a generation parameter used for generating the file, and wherein different resolutions are displayed as the reading parameter and the generation parameter in a case where the file is to be generated on the second condition.

13. The control apparatus according to claim 11, wherein the first condition includes a compression setting being disabled, and wherein
the second condition includes the compression setting being enabled.

14. The control apparatus according to claim 12, wherein the control unit displays the generation parameter, the reading parameter, and a basis for the generation parameter in a case where the file is to be generated on the second condition.

15. A method for controlling a control apparatus for controlling a scanner, comprising:
determining that a reading parameter used for reading a document image by the scanner will be displayed in a case where a file of the document image is to be generated on a first condition and that both a generation parameter used for generating the file and the reading parameter will be displayed in a case where the file is to be generated on a second condition being different from the first condition; and
displaying the determined reading parameter.
